(19) United States
(12) Patent Application Publication
(10) Pub. No.: US 2022/0019340 A1
(43) Pub. Date: Jan. 20, 2022

(54) Social knowledge graph for collective learning

(71) Applicant: yuchen du, Shenzhen (CN)

(72) Inventor: yuchen du, Shenzhen (CN)

(21) Appl. No.: 17/365,177

(22) Filed: Jul. 1, 2021

Related U.S. Application Data
(60) Provisional application No. 63/051,897, filed on Jul. 15, 2020.

(51) Int. Cl. G06F 3/0484

(52) U.S. Cl. CPC G06F 3/04845; G06F 3/04842

(57) ABSTRACT

The invention describes a method for users to create, edit and share heterogeneous graphs representing linked knowledge and information, where a graph is a concept in computer science able to represent complex linked data.

### REFERENCES CITED

### Provisional Patent Application

U.S. 63/051,897 Social knowledge graph for collective learning, Yuchen Du

### U.S. Patent Documents

U.S. Pat. No. 6,256,032 Method and apparatus for organizing and processing information using a digital computer, Harlan M. Hugh
U.S. Pat. No. 5,506,937 B1 Concept mapbased multimedia computer system for facilitating user understanding of a domain of knowledge, Harlan M. Hugh
U.S. Pat. No. 6,031,537 A Method and apparatus for displaying a thought network from a thought's perspective, Harlan M. Hugh

### BACKGROUND OF THE INVENTION

Field of the Invention: This invention relates to the processing, visualization and sharing of linked information.

This invention can be think of an improvement of current mind mapping apps. Current arts usually emphasis on single user scenario and usually do not allow linking between different users, while this invention promotes linking between users. In addition, this invention allows for unlimited types of connection, whereas for current mind mapping apps, users are usually limited to a set of predefined connections.

### SUMMARY OF THE INVENTION

The invention describes a way to represent knowledge and information with graphs in the context of multiple users.

### BRIEF DESCRIPTION OF THE DRAWINGS

FIG. 1 displays one possible way of implementation as a website, shown in a browser. It shows how a knowledge graph is visualised, describing basic information of cats. The circles and enclosed text are nodes, representing objects. Arrows and their accompanying texts are edges, displaying the relationships between objects.

FIG. 2 shows the graphical interface for users to add nodes and edges.

FIG. 3 describes the flow chart of a program to retrieve and draw a graph with or without remote server systems.

FIG. 4 describes the program flow chart of navigation of a graph, with or without remote server system.

FIG. 5 describes the program flow chart for users to edit graphs.

FIG. 6 describes the program flow chart for users to add nodes or edges.

### DETAILED DESCRIPTION

Definition of the User Graph

A graph can contain a plurality of nodes, whereas a node can denote a many types of information like text, image, link, etc, and nodes are connected by a plurality of edges, and together nodes and edges constitute graphs, which can represent complex knowledge and information and the relationship between them.

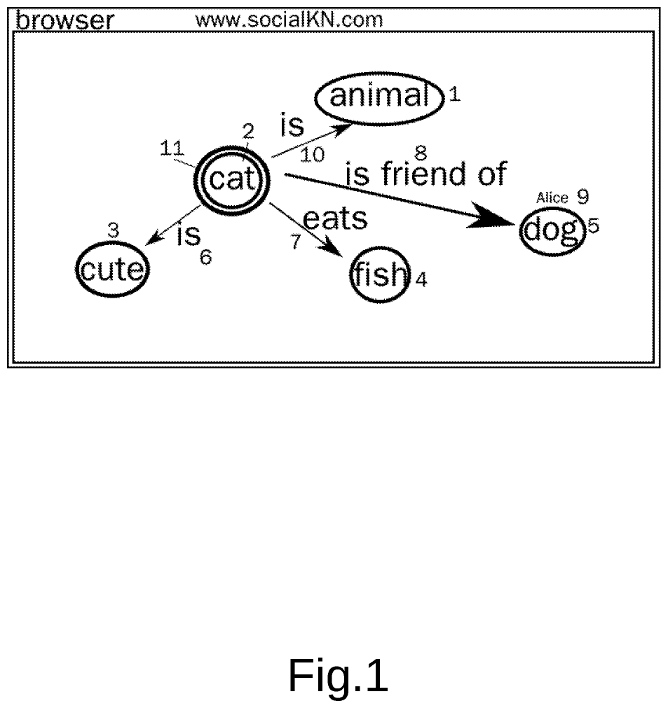

For example, In FIG. 1, the parts 1,2,3,4,5 shows texts enclosed by circles called nodes. 6,7,8,10 are edges consisting of an arrow and text. Nodes represent objects, and edges display the relationships between those objects. Thus, this kind of graph is an alternative way to convey meanings and information, in contrast with sentences, but it is more concise. Notice that the cat node 2 is connected to the dog node 5 by edge 8 “is friend of”, which is created by other user Alice. The part 9 explicitly shows that the node 5 belongs to another user Alice. Lots of users may create many graphs, and as users link each others node, those graphs will be interconnected into a huge graph, forming a huge collective knowledge base.

When a user first signs up, a unique user id is generated and a user name is set up so that different users can identify which user the nodes belong to when they add connections between nodes from different user graphs.

The nodes and edges are stored in a graph database, which is commonly used today like the relational database and one famous brand is Neo4j. Nodes and edges are associated with a unique id which can be used to retrieve other information for that node or edge.

Positioning of the Nodes in the Graph

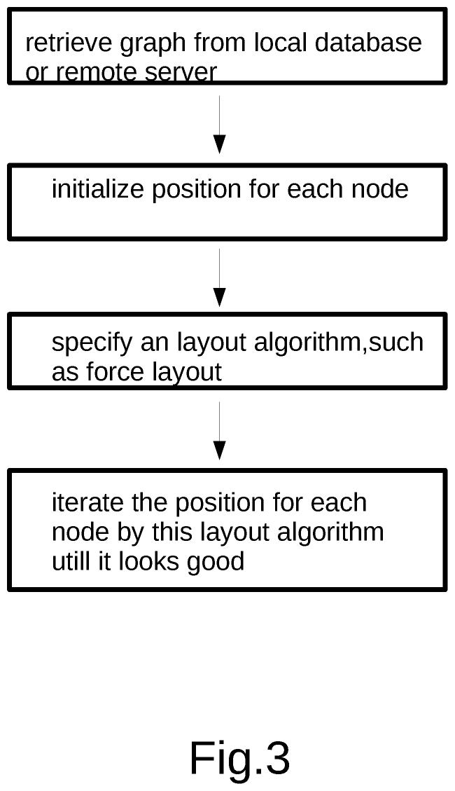

FIG. 3 shows how to get and display part of the user's graph on the display devices of client system. After getting a graph from either local database or remote server, a initial position is given for each node. A layout algorithm is used to calculate the optimal position for each node to make the graph looks nice(for example, makes the edge not overlapping).

Navigation of the Graph

The invention allows users to create very big graphs and further link them to graphs of other users, so that it is impossible to show the whole graph on screen and even if the graph is not very big, it will be too noisy to show everything on screen at once. Thus it is essential to provide a means to show only a part of the graph and let users move their attention along the graph. An example of whole user graph is not shown, but only the retrieved part of the graph is displayed in FIG. 1.

To indicate what information the user is currently looking at, this invention provides a means to specify the current attention of a user, called “focus”. A focus can be highlighting, or a circle around a node. In FIG. 1, the outer circle 11 indicates current user focus. The focus can be moved by arrow keys in keyboard or by touch from touchscreen. After the focus is moved, an instruction is sent to server to retrieve the neighbour node of the new focus, showing information around the new focus, where neighbour nodes are nodes which are connected to the focus node by some edges.

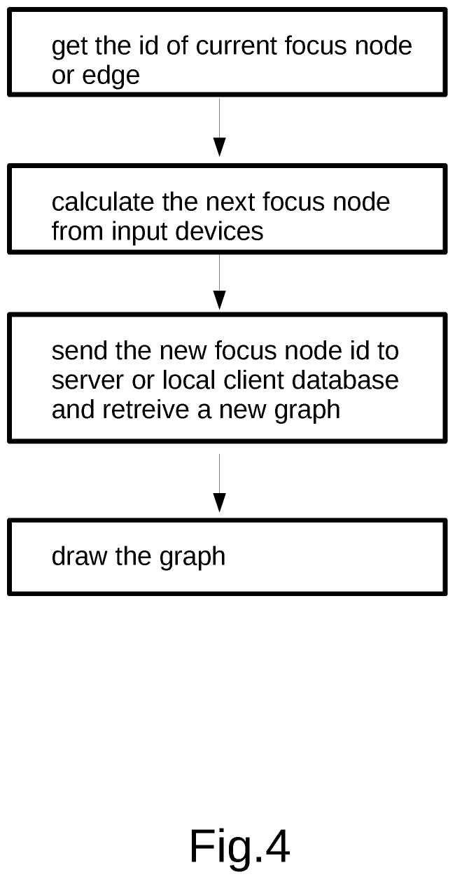

FIG. 4 describes the flow chart to navigate to a new part of the graph. In addition, if the implementation is a client system only one without a server system, the neighbour nodes are retrieved from the local database system.

Editing

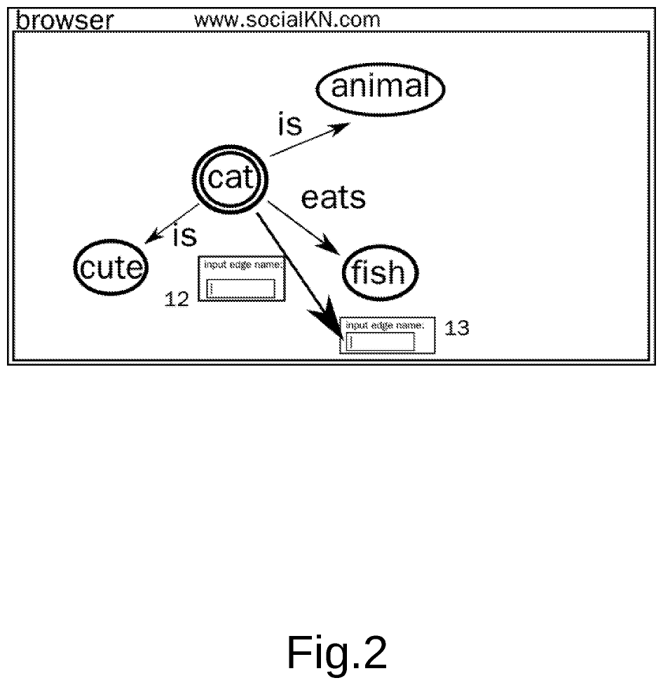

Users can edit the graph with various input devices, like touch screen, keyboard or mouse, including the name of the node or edge, the image or other resources linked to the node or edge. In FIG. 2, two popup dialogs is present when a user ask to add more data. Dialog 12 receives input of node name, another dialog 13 is for edge name. The information is then submitted to client storage system or server system depending on the implementations.

Implementation

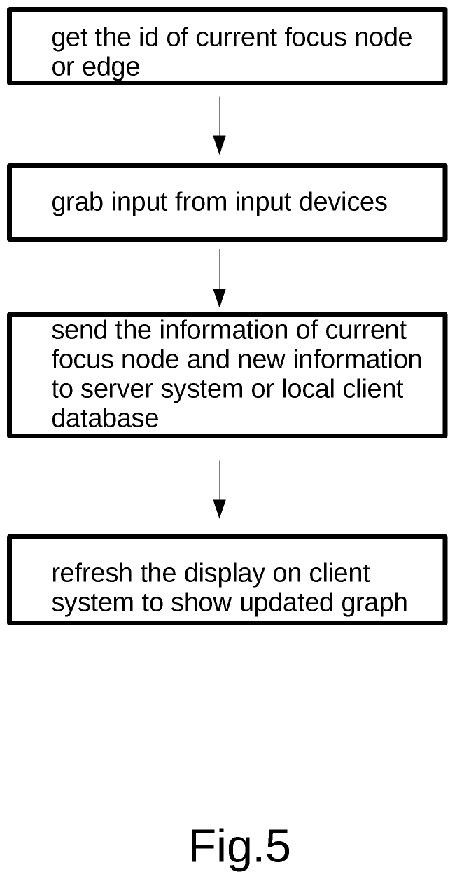

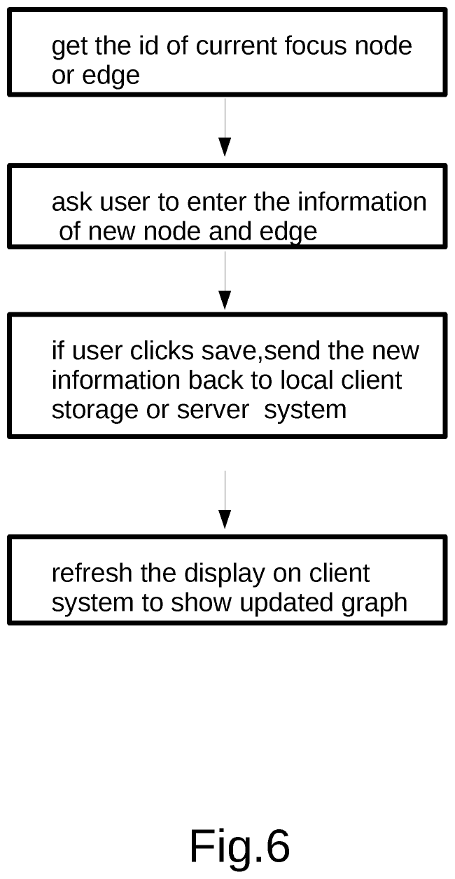

FIG. 3 to FIG. 6 shows the flowchart of the invention, which can be then implemented with many kinds of programming language and later compiled and deployed on clients and servers by average software programmers.

This invention can be both implemented as a standalone program(contains only client system, requires no internet) or a client-server system that requires internet. The standalone implementation stores all data on client system (computer, mobile phones, etc), and the client-server scenario only stores parts of the data on client system and retrieves data from server system when necessary.

I claim:

1. A method for organizing, navigating and visualizing information, comprising:
(a) a user graph containing a plurality of nodes and edges, where nodes and edges contains information such as text, image, hyperlink and the information of the user;
(b) displaying a part of said user's graph with a focus of a specific node, and the said part of the said user's graph is retrieved from a client system or a server system based on said focus;
(c) Said focus can be switched with signals from input devices like keyboard, mouse and touchscreen;
(d) a node of one user's graph can be linked to another node of a different user's graph.

2. A method for organizing, navigating and visualizing information, comprising:
(a) a user graph containing a plurality of nodes and edges, where nodes and edges display information such as text, image, hyperlink and the identity of the user;
(b) displaying a part of said user's graph with a focus of a specific node, and the said part of the said user's graph is retrieved based on the condition whether the said focus node and its neighbour nodes are connected by edges;
(c) Said focus can be switched from one node to another node by signals from input devices like keyboard, mouse and touchscreen;
(d) a node of one user's graph can be linked to another node of a different user's graph.

3. A system for editing, displaying and sharing of information, comprising:
(a) an edit system for users to create user graphs via input dialogs, where a plurality of nodes and edges with information such as text, image, hyperlink and the identity of the user can be input;
(b) a display system consisting of showing a focus of a specific node and a part of said user's graph, and the said part of the said user's graph is retrieved based on the relationship of said focus node and its neighbour nodes, and if a node of one user's graph is linked to another node of a different user's graph, showing an identification of the user of the foreign node where said identification method includes user name and unique user id;
(c) an interaction system that said focus can be switched from one node to another node by signals from a user's input devices like keyboard, mouse and touchscreen;
(d) a data storage system that allows nodes of one user's graph to be linked to another node of a different user's graph.
